(19) United States
(12) Patent Application Publication
(10) Pub. No.: US 2018/0145554 A1
(43) Pub. Date: May 24, 2018

(54) Resistance Covering For A Corona Shield Of An Electric Machine

(71) Applicant: Siemens Aktiengesellschaft, München (DE)

(72) Inventors: Steffen Lang, Hallerndorf (DE); Bastian Plochmann, Neustadt an der Aisch (DE)

(73) Assignee: Siemens Aktiengesellschaft, Muenchen (DE)

(21) Appl. No.: 15/576,917

(22) PCT Filed: May 19, 2016
(86) PCT No.: PCT/EP2016/061194

§ 371 Date: Nov. 27, 2017

(30) Foreign Application Priority Data
May 26, 2015 (DE) 10 2015 209 594.0

(51) Int. Cl. H02K 3/40

(52) U.S. Cl. CPC H02K 3/40

(57) ABSTRACT

The present disclosure relates to electrical machines. The teachings thereof may be embodied in a resistance coating for a corona shielding system in an electrical machine, for example a medium- or high-voltage machine, such as a generator in a power plant for generation of electrical energy, but also other electrical equipment having a relatively high rated voltage, such as transformers, bushings, cables etc. In some embodiments, a resistance coating for an electrical machine may include: an electrically insulating matrix; electrically conductive particles incorporated into the matrix in the form of a metal oxide in platelet form with a conductivity generated by doping. A percolation threshold of the resistance coating is exceeded in two orthogonal directions providing a conductivity of the resistance coating in the two orthogonal directions higher by at least a factor of 10, than in a third orthogonal direction. The particles include an aligned flake structure in the layer plane parallel to the third orthogonal direction providing an increased discharge resistance normal to the flake structure. Uncoated metal oxide particles in platelet form are conductive.

### CROSS-REFERENCE TO RELATED APPLICATIONS

This application is a U.S. National Stage Application of International Application No. PCT/EP2016/061194 filed May 19, 2016, which designates the United States of America, and claims priority to DE Application No. 10 2015 209 594.0 filed May 26, 2015, the contents of which are hereby incorporated by reference in their entirety.

### TECHNICAL FIELD

The present disclosure relates to electrical machines. The teachings thereof may be embodied in a resistance coating for a corona shielding system in an electrical machine, for example a medium- or high-voltage machine, such as a generator in a power plant for generation of electrical energy, but also other electrical equipment having a relatively high rated voltage, such as transformers, bushings, cables etc.

### BACKGROUND

Ever higher-power electrical machines, for example generators, are being developed since advancing technology can take advantage of ever higher power densities. A high-powered generator, for example a turbo generator, may include a turbo generator stator with a stator lamination stack and a multitude of generator winding bars that are electrical conductors. The stator lamination stack has a multitude of grooves in which the conductors are mounted. The conductors protrude here from the stator lamination stack.

The main insulation, comprising a resistance coating, of this winding from the lamination stack is under high electrical stress. In operation, high voltages arise and must be dissipated in the insulation volume between the conductor bar and the lamination stack at ground potential. At the edges of the laminations, increases in field arise, and then in turn cause partial discharges. These partial discharges may lead to very significant local heating. This takes place in air and in direct contact with the organic-based materials of the insulation systems, including the resistance coating of the corona shielding system, and may result in conversion of the organic materials to volatile products of low molecular weight, for example to CO₂.

An important constituent of the corona shielding system is the outer corona shield (OCS), especially an OCS with terminal corona shielding (TCS). In larger generators and electric motors, the outer corona shield is applied directly to the surface of the winding insulation. The OCS currently consists of tapes or varnishes.

The resistance coating for the corona shielding system has been implemented either by means of paints composed of drying and/or curable matrices, for example resins, which have been provided with electrically conductive particles and are applied directly to the main insulation and/or together with tapes. These tapes are the result of impregnating nonwoven or woven fabrics with thermoset binders and may, as required, comprise electrically conductive particles, for example carbon black, in varying concentration. However, the corona shielding systems available on the market are not partial discharge-resistant, and the fillers in the impregnated nonwoven and woven fabrics have a tendency to break out.

EP 2362 399 B1 teaches a resistance coating for a corona shielding system, comprising a carrier matrix, for example a varnish or a resin, and particles incorporated therein that have been provided with a coating. Particles used therein are those such as the core-shell (CS) particles that are of any desired shape and consist of a carrier “core” and a coating “shell”, for example filler particles composed of mica, aluminum oxide, silicon oxide and/or silicon carbide and/or an undoped metal oxide.

The sheet resistance of the outer corona shield may be relatively low and must not go above or below a certain upper and lower limit (typical values 0.2 to 10 kΩ). The resistance in axial direction should be very high, and very low in radial direction. The sheet resistance of a terminal corona shield has a much higher ohm value (typical values 10⁸-10¹⁰Ω). Correspondingly high electrical field strengths in the insulation system and hence correspondingly high electrical partial discharge activity result in complete incineration of the outer corona shield in operation and hence premature aging of the insulation and, in the worst case, in a ground fault of the electrical machine, corresponding to an irreversible complete failure of the machine.

### SUMMARY

It is therefore an object of the present disclosure to overcome the disadvantages described above, for example in a resistance coating for a stable corona shielding system. Some embodiments may include a resistance coating for an electrical machine based on an electrically insulating matrix that cures either chemically or physically, comprising electrically conductive particles that are incorporated into this matrix and are in the form of a metal oxide in platelet form, the electrical conductivity of which is generated by doping, wherein the percolation threshold is exceeded in two spatial directions and there is very good conductivity which is higher, especially higher by a factor of 10, than in the third spatial direction, wherein an aligned flake structure has been developed in the preferential layer plane and this achieves high partial discharge resistance at right angles to the flake structure, characterized in that these metal oxide particles in platelet form are conductive in the uncoated state.

In some embodiments, the material of the matrix may be polymeric, i.e. made of plastic, or glass or of ceramic.

In some embodiments, the electrically conductive particles comprise a mixture of at least two metal oxides.

In some embodiments, the electrically conductive particles are at least partly in crystalline form.

In some embodiments, the electrically conductive particles are at least partly in polycrystalline form.

In some embodiments, the electrically conductive particles are in the form of solid particles.

In some embodiments, the electrically conductive particles are in the form of particles having pores and/or comprising a cavity.

In some embodiments, the metal oxide is selected from the group of the following compounds: metal oxide in binary and tertiary mixed phase of the transition metals, the alkali metals and/or alkaline earth metals, especially tin oxide, zinc oxide, zinc stannate, titanium oxide, lead oxide, silicon carbide, silicon oxide and/or aluminum oxide.

In some embodiments, the doping element for the metal oxide is selected from elements from the group of main groups 3 to 5 of the transition metals, including the rare earths.

In some embodiments, the doping element for the metal oxide is selected from the group comprising antimony, indium, cadmium.

In some embodiments, the electrically conductive particles have a coating having only an insignificant effect, if any, on the electrical conductivity of the electrically conductive particles.

In some embodiments, the electrically conductive particles have a coating of one or more silanes, of waterglass and/or an undoped metal oxide.

In some embodiments, the electrical resistance of the resistance coating is between 1 and 10¹³Ω), measured at a field strength of 1 V/mm.

In some embodiments, the electrical nonlinearity of the resistance coating material is between 1 and 7.

In some embodiments, the weight of the electrically conductive particles is between 10% and 80% by weight, based on the overall material of the resistance coating.

In some embodiments, the electrically conductive particles also comprise particles in rod form and/or globular particles.

In some embodiments, the particles in rod form and/or globular particles are at least partly in crystalline form.

### DETAILED DESCRIPTION

Accordingly, the teachings of the present disclosure may be embodied in a resistance coating for an electrical machine based on an electrically insulating matrix that cures either chemically or physically, comprising electrically conductive particles that are incorporated into this matrix and are in the form of a metal oxide in platelet form, the electrical conductivity of which is generated by doping, wherein the percolation threshold is exceeded in two spatial directions and there is very good conductivity which is higher by about a factor of 10 than in the third spatial direction, wherein an aligned flake structure has been developed in the preferential layer plane and so high partial discharge resistance at right angles to the flake structure is achieved, characterized in that these metal oxide particles in platelet form, which create the flake structure in the matrix, are conductive in the uncoated state.

By contrast with the prior art, which includes only electrically conductive core-shell particles as fillers, substrate-free, i.e. electrically conductive, “shell” particles without a “core”, are used here as filler. An improved resistance coating for an outer and/or terminal corona shield shows marked anisotropy in its resistance characteristics.

In some embodiments, the matrix material used may be a plastic, a polymeric plastic, a glass and/or another ceramic.

In some embodiments, the pigment bulk concentration in the preferential layer plane is above the percolation threshold, with a significant decline in the macroscopic resistance within this region, which is in a saturation range for relatively high filler levels. Thus, a further increase in the pigment bulk concentration does not result in a significant change in the electrical resistance of the composite material layer. For applications of this kind, it is advisable to use planar particles, the shape of which deviates from the spherical shape and is thus platelet-shaped. These have a lower percolation threshold compared to spherical or globular particles, which means that it is possible to work at lower pigment bulk concentrations, which brings advantages in terms of processing and materials.

In some embodiments, with regard to their partial discharge resistance, the electrically conductive particles are used because, by virtue of the shape and material thereof, they form a kind of armor in the resistance coating that brings about the partial discharge resistance. As a result, they have the effect of greater chemical stability and are less temperature-sensitive because they are in the form of aligned platelets in the resistance coating in the matrix. The resistance coating may have an electrical square resistance of 1 to 10⁵Ω, e.g. of 10¹ to 10³Ω.

In some embodiments, the filler in the matrix, for example, the electrically conductive particles, may be composed of metal oxides, which fundamentally are of zero or only low conductivity, but have doping. With the aid of the doping, it is possible to adjust the conductivity of the filler material.

In some embodiments, the metal oxide is selected from the group of: metal oxide in binary and tertiary mixed phase of all alkali metal, alkaline earth metal and/or all transition metal elements, especially tin oxide, zinc oxide, zinc stannate, titanium oxide, lead oxide, silicon carbide, silicon dioxide and/or aluminum oxide. The conductivity of metal oxide may be adjusted by doping, for example, the doping element for the metal oxide being selected from elements from the group of main groups 3 to 5 of the transition metals, including the rare earths, for example from the group of the following elements: antimony, indium, and/or cadmium.

In some embodiments, the electrically conductive particles are in the form of solid particles. In some embodiments, the electrically conductive particles are in the form of particles having pores and/or at least one cavity. In some embodiments, the electrically conductive particles have a coating that only insignificantly affects the electrical conductivity of the filler, if at all. In some embodiments, this coating is composed, for example, of one or more silanes, of waterglass and/or an undoped metal oxide.

In some embodiments, the resistance coating also comprises further fillers in the nonconductive matrix. Fillers of this kind and further additives are known.

In some embodiments, the electrical resistance of the resistance coating is between 1 and 10¹³Ω, measured at a field strength of 1 V/mm. In some embodiments, the electrical nonlinearity of the resistance coating material is between 1 and 7.

In some embodiments, the weight of the electrically conductive particles is between 10% and 80% by weight, based on the overall resistance coating material.

To establish a particular conductivity in the matrix, some embodiments incorporate particles in platelet form and/or in rod form into the matrix, with a high aspect ratio of 5 or greater. In some embodiments, however, these are supplemented by globular particles.

Electrically conductive metal oxides form an important material class in the application for potential controls in high- and medium-voltage machines. Important representatives here are metal oxides in platelet form and/or in rod form and/or mixed metal oxides, especially those having a crystalline or polycrystalline component. Since metal oxides preferably have a ceramic structure, they may be in a crystal polymorph, i.e. in crystalline form. In some embodiments of this sort, the metal oxide has a comparatively planar crystal structure, such as one in rod or platelet form.

In some embodiments, the electrically conductive particles are, for example, doped polycrystalline tin oxides and/or metal oxides having planar structure, including in the crystalline or polycrystalline state, for example doped aluminum oxide and doped silicon oxide. In some embodiments, they replace carbon black- and/or graphite-containing resistance coatings.

In some embodiments, it is no longer necessary for any mica to be degraded for production of a resistance coating. It is supplemented by tin, the raw material which is typically applied as functional layer, as a “shell”, to mica. It is possible to achieve higher thermal conductivities through the use of functional particles such as aluminum oxide.

Planar particles such as the particles in platelet form may increase the erosion pathway of partial discharges and hence the lifetime of an insulation system. Planar particles have a low percolation threshold, which means that much less filler is required for equal conductivities in the resistance coating material. This is especially also true in respect of the comparison with globular filler particles. Substrate-free particles are generally less costly to produce than substrate-bearing core-shell particles. Ceramic fillers are resistant to partial discharges compared to carbon black or graphite, for example.

In some embodiments, there are anisotropic electrical conductivities, with a distinctly higher electrical conductivity in the direction of the aligned electrically conductive particles in platelet form than at right angles thereto. This is by a factor, for example, of 10.

The teachings herein may be used to design a resistance coating for a corona shielding system of an electrical machine, for example a medium- or high-voltage machine, such as a generator in a power plant for generation of electrical energy, but also other electrical equipment having a relatively high rated voltage, such as transformers, bushings, cables, etc. By contrast with the core-shell particles that have been customary to date and have been used as a filler for adjusting the electrical conductivity in the resistance coating, uncoated particles are used in the present case to establish electrical conductivity.

What is claimed is:

1. A resistance coating for an electrical machine, the coating comprising:
an electrically insulating matrix;
electrically conductive particles incorporated into the matrix in the form of a metal oxide in platelet form;
the electrically conductive particles with a conductivity generated by doping;
wherein a percolation threshold of the resistance coating is exceeded in two orthogonal directions providing a conductivity of the resistance coating in the two orthogonal directions higher by at least a factor of 10, than in a third orthogonal direction;
wherein the particles include an aligned flake structure in the layer plane parallel to the third orthogonal direction providing a increased discharge resistance normal to the flake structure;
wherein the metal oxide particles in platelet form are conductive in the uncoated state.

2. The resistance coating as claimed in claim 1, wherein the electrically insulating matrix comprises a polymer, a glass, and/or a ceramic.

3. The resistance coating as claimed in claim 1, wherein the electrically conductive particles comprise a mixture of at least two metal oxides.

4. The resistance coating as claimed in claim 1, wherein the electrically conductive particles comprise a crystalline material.

5. The resistance coating as claimed in claim 1, wherein the electrically conductive particles comprise a polycrystalline material.

6. The resistance coating as claimed in claim 1, wherein the electrically conductive particles comprise solid particles.

7. The resistance coating as claimed in claim 1, wherein the electrically conductive particles comprises particles having pores and/or a cavity.

8. The resistance coating as claimed in claim 1, wherein the metal oxide is selected from the group consisting of the following compounds: metal oxide in binary and tertiary mixed phase of the transition metals, the alkali metals and/or alkaline earth metals, tin oxide, zinc oxide, zinc stannate, titanium oxide, lead oxide, silicon carbide, silicon oxide, and/or aluminum oxide.

9. The resistance coating as claimed in claim 1, wherein the doping element comprises at least one elements selected from the group consisting of: main groups 3 to 5 of the transition metals, including the rare earths.

10. The resistance coating as claimed in claim 1, wherein the doping element for the metal oxide comprises at least one elements selected from the group consisting of: antimony, indium, and cadmium.

11. The resistance coating as claimed in claim 1, wherein the electrically conductive particles include a coating having only an insignificant effect on the electrical conductivity of the electrically conductive particles.

12. The resistance coating as claimed in claim 11, wherein the electrically conductive particles have a coating comprising a silane, a waterglass, and/or an undoped metal oxide.

13. The resistance coating as claimed in claim 1, wherein an electrical resistance of the resistance coating is between 1 and 10¹³Ω, measured at a field strength of 1 V/mm.

14. The resistance coating as claimed in claim 1, wherein an electrical nonlinearity of the resistance coating material is between 1 and 7.

15. The resistance coating as claimed in claim 1, wherein a weight of the electrically conductive particles is between 10% and 80% by weight of the entire resistance coating.

16. The resistance coating as claimed in claim 1, wherein the electrically conductive particles comprise particles in rod form and/or globular particles.

17. The resistance coating as claimed in claim 16, wherein the particles are at least partly in crystalline form.
